(19) United States
(12) Patent Application Publication
(10) Pub. No.: US 2023/0010392 A1
(43) Pub. Date: Jan. 12, 2023

(54) METHOD FOR ACTION RECOGNITION IN VIDEO AND ELECTRONIC DEVICE

(71) Applicant: GUANGDONG OPPO MOBILE TELECOMMUNICATIONS CORP., LTD., Dongguan (CN)

(72) Inventor: Jenhao Hsiao, Palo Alto, CA (US)

(21) Appl. No.: 17/950,824

(22) Filed: Sep. 22, 2022

Related U.S. Application Data
(63) Continuation of application No. PCT/CN2021/083850, filed on Mar. 30, 2021.
(60) Provisional application No. 63/003,348, filed on Apr. 1, 2020.

(51) Int. Cl. G06V 20/40; G06V 10/62

(52) U.S. Cl. CPC G06V 20/41; G06V 10/62; G06V 20/47

(57) ABSTRACT

A method for action recognition in a video is described. The method includes inputting a plurality of consecutive clips divided from the video into a convolutional neural network (CNN), and obtaining a set of clip descriptors; processing the set of clip descriptors via a Bi-directional Attention mechanism, and obtaining a global representation of the video; and performing video-classification for the global representation of the video such that action recognition is achieved.

### CROSS-REFERENCE TO RELATED APPLICATION(S

The present disclosure is a continuation of International (PCT) Patent Application No. PCT/CN2021/083850 filed on Mar. 30, 2021, which claims priority to U.S. Provisional Pat. Application, Serial No. 63/003,348, filed on Apr. 1, 2020, the contents of both of which are herein incorporated by reference in their entireties.

### TECHNICAL FIELD

The present disclosure generally relates to the technical field of video-processing, and in particular relates to a method and an apparatus for action recognition in a video, and an electronic device.

### BACKGROUND

Most existing video action recognition techniques rely on trimmed videos as their inputs. However, videos in the real-world exhibit very different properties. For example, the videos are often several minutes long, where brief relevant clips are often interleaved with segments of extended duration containing little change.

### SUMMARY

According to one aspect of the present disclosure, a method for action recognition in a video is provided. The method includes inputting a plurality of consecutive clips divided from the video into a convolutional neural network (CNN), and obtaining a set of clip descriptors; processing the set of clip descriptors via a Bi-directional Attention mechanism, and obtaining a global representation of the video; and performing video-classification for the global representation of the video such that action recognition is achieved.

According to another aspect of the present disclosure, an apparatus for action recognition in a video is provided. The apparatus include an obtaining module, configured for inputting a plurality of consecutive clips divided from the video into a convolutional neural network (CNN), and obtaining a set of clip descriptors; a processing module, configured for processing the set of clip descriptors via a Bi-directional Attention mechanism, and obtaining a global representation of the video; and a classification module, configured for performing video-classification for the global representation of the video such that action recognition is achieved.

According to yet another aspect of the present disclosure, an electronic device is provided. The electronic device includes a processor and a memory storing instructions. The instructions when executed by the processor, causes the processor to perform the method as described in above aspects.

According to yet another aspect of the present disclosure, a non-transitory computer-readable storage medium is provided. The non-transitory computer-readable storage medium stores instructions, when executed by a processor, causing the processor to perform the method as described in above aspects.

### BRIEF DESCRIPTION OF DRAWINGS

In order to make the technical solution described in the embodiments of the present disclosure more clearly, the drawings used for the description of the embodiments will be briefly described. Apparently, the drawings described below are only for illustration but not for limitation. It should be understood that, one skilled in the art may acquire other drawings based on these drawings, without making any inventive work.

FIG. 1a is a diagram of a framework of one current technique for action recognition in a video;

FIG. 1b is a diagram of a framework of another current technique for action recognition in a video;

FIG. 2 is a flow chart of a method for action recognition in a video according to some embodiments of the present disclosure;

FIG. 3 is a diagram of a network architecture used for a method for action recognition in a video according to some embodiments of the present disclosure;

FIG. 4 is a structural schematic view of an apparatus for action recognition in a video according to some embodiments of the present disclosure;

FIG. 5 is a structural schematic view of an electronic device according to some embodiments of the present disclosure.

### DETAILED DESCRIPTION

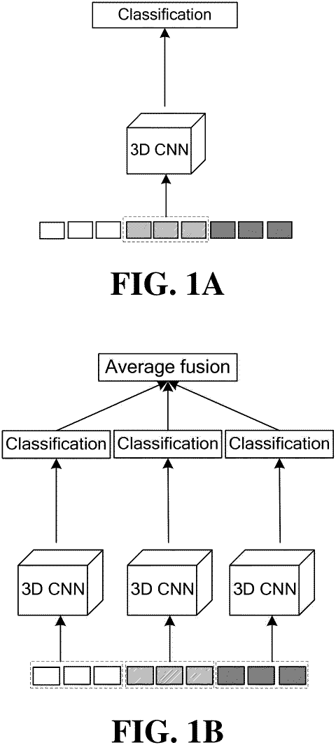

As videos exhibit very different properties, current video action recognition techniques that partially capture the local temporal knowledge (e.g., within 16 frames) or heavily rely on static visual information can hardly describe motions accurately from a global view, and is thus prone to fail due to the challenges in extracting salient information. For example, some techniques randomly/uniformly select clips. As shown in FIG. 1a, central clips are only selected in a video for recognition. For another example, some techniques conduct analysis of all clips. As shown in FIG. 1b, these techniques average the results from several clips to get the final classification (which may be called as average fusion).

To solve the above problems, the present disclosure provides a method and apparatus for action recognition in a video, and an electronic device, which greatly enhances action recognition accuracy in videos and enhance recognition of lasting motions in videos.

Below embodiments of the disclosure will be described in detail, examples of which are shown in the accompanying drawings, in which the same or similar reference numerals have been used throughout to denote the same or similar elements or elements serving the same or similar functions. The embodiments described below with reference to the accompanying drawings are exemplary only, meaning they are intended to be illustrative of rather than limiting the present disclosure.

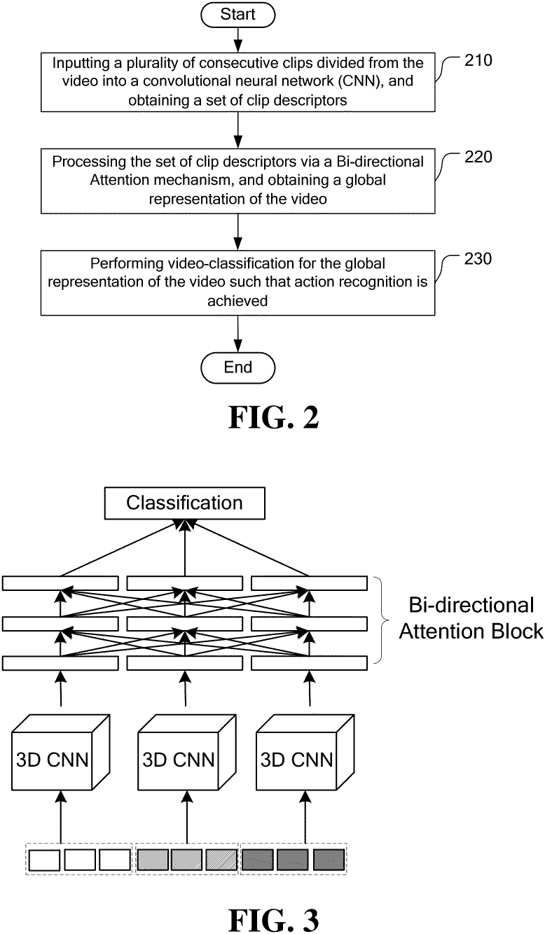

FIG. 2 is a flow chart of a method for action recognition in a video according to some embodiments of the present disclosure. The method may be performed by an electronic device, which includes, but is not limited to, a computer, a server, etc. The method includes actions/operations in the following blocks.

At block 210, the method inputs a plurality of consecutive clips divided from the video into a convolutional neural network (CNN), and obtains a set of clip descriptors.

The video is divided into a plurality of consecutive clips, and each clip contains 16 stacked frames. The consecutive clips are set as input of the CNN, and then the CNN outputs the set of clip descriptors. The CNN may include a plurality of convolutional layers for extracting corresponding features and a plurality of fully connected layers, and a convolutional kernel for each convolutional layer in the CNN is in a plurality of dimensions, for example, 3 dimensions, which are not limited herein. For example, the CNN includes 8 convolutional layers and 2 fully connected layers. An input shape of one batch data formed by the consecutive clips is C × T × H ×W × ch, where C denotes the number of consecutive clips, T represents the number of frames which are stacked together with a height H and a width W, and ch denotes the channel number, which is 3 for RGB images.

In some examples, for inputting a plurality of consecutive clips divided from the video into a convolutional neural network (CNN) and obtaining a set of clip descriptors at block 210, for each convolutional layer of the plurality of convolutional layers, data of the plurality of consecutive clips are computed among the plurality of dimensions simultaneously, such that the set of clip descriptors is obtained.

In one example, the CNN may be a 3D CNN. The 3D CNN may include a plurality of 3D convolutional layers and a plurality of fully connected layers, which are not limited herein. The 3D convolutional layers are configured for extracting corresponding features of the clips, and the last fully connected layers in the 3D CNN is configured for outputting a clip descriptor. For example, the 3D CNN includes 8 3D convolutional layers and 2 fully connected layers. In the example of the CNN being the 3D CNN, a convolutional kernel for each 3D convolutional layer in the 3D CNN is in 3 dimensions, being k × k × k. Given that the input clips are denoted as X = {x₁, x₂, ..., x_{c}}, data of the consecutive clips X = {x₁, x₂, ..., x_{c}} are computed among the 3 dimensions simultaneously, and then the output of the 3D CNN is a set of clip descriptors V = {v₁, v₂, ..., v_{c}}, where v ∈ R^{D} is the output of the last fully connected layer in the 3D CNN and D is 2048.

At block 220, the method processes the set of clip descriptors via a Bi-directional Attention mechanism, and obtains a global representation of the video.

The set of clip descriptors is processed via the Bi-directional Attention mechanism, such that the global representation of the video is obtained.

The Bi-directional Attention mechanism is configured to capture inter-clip dependencies for short-range video segments and long-range video segments of the video and then generate a global representation of the video. The global representation of the video is configured for extracting salient information in the video easily, and thus this makes action recognition more accuracy. Specifically, the Bi-directional Attention mechanism may be represented by the Bidirectional Attention Block.

At block 230, the method performs video-classification for the global representation of the video such that action recognition is achieved.

The video-classification is performed for the global representation of the video, and thus, action recognition is achieved.

In these embodiments, the consecutive clips of the video are input into the convolutional neural network (CNN) and then a set of clip descriptors of the video is obtained. Meanwhile, the set of clip descriptors is processed via a Bi-directional Attention mechanism to obtain the global representation of the video, and the video-classification is performed for the global representation of the video. Thus, action recognition is achieved. With the Bi-directional Attention mechanism, the global representation of the video is obtained, which is easy to achieve action recognition with high accuracy. Thus, this can greatly enhance action recognition accuracy in videos and enhance recognition of lasting motions in videos.

In order to facilitate the understanding of the present disclosure, a network architecture for the above the method according to some embodiments of the present disclosure is described in detail below.

As shown in FIG. 3, the network architecture includes a 3D CNN, Bi-directional Attention Block, and classification.

The consecutive clips of the video are set as input of the CNN. An input shape of one batch data formed by the consecutive clips is C × T × H ×W × ch, where C denotes the number of consecutive clips, T represents the number of frames which are stacked together with a height H and a width W, and ch denotes the channel number, which is 3 for RGB images. The 3D CNN may include a plurality of 3D convolutional layers and a plurality of fully connected layers, which are not limited herein. The 3D convolutional layers are configured for extracting corresponding features of the clips, and the last fully connected layers in the 3D CNN is configured for outputting a clip descriptor. For example, the 3D CNN includes 8 3D convolutional layers and 2 fully connected layers. In the example of the CNN being the 3D CNN, a convolutional kernel for each 3D convolutional layer in the 3D CNN is in 3 dimensions, being k × k × k. Given that the input clips are denoted as X = {x₁, x₂, ..., x_{c}}, and then the output of the 3D CNN is a set of clip descriptors V = {v₁, v₂, ..., v_{c}}, where v ∈ R^{D} is the output of the last fully connected layer in the 3D CNN and D is 2048.

It should be noted that, in the network architecture of FIG. 3, there are three same 3D CNNs, which is determined according to actual requirements when it is used for video action recognition. And it is not limited to these three 3D CNNs.

The Bi-directional Attention Block uses Multi-head Attention, in which each head attention forms a representation subspace. Thus, the Bi-directional Attention Block can focus on different aspects of information. That is, Multi-head attention allows to further jointly attend to information from different representation subspaces at different positions, which can further refine the global representation of the video.

The output of the 3D CNN is input into the Bi-directional Attention Block, a global representation of the video is obtained. Then the global representation of the video is classified, thus action recognition is achieved.

Different action recognition techniques are compared, including one in FIG. 1a, one in FIG. 1b, and the method according to some embodiments of the present disclosure with the network architecture in FIG. 3, Table 1 shows the accuracy comparison of these methods in Kinetics-600, which consists 600 action classes and contains around 20k videos for validation. As can be seen that the technique in FIG. 1a, which assume that the central clip is the most related event and directly use the central clip as the input, can achieve the poorest 58.58% top- 1 accuracy. This poor accuracy is mainly due to the lack of fully utilizing the information in the video (e.g., the rest relevant clips). Naive average of clips is another popular technique in FIG. 1b, but it can only achieve 65.3% top-1 accuracy. Since an action is usually complex and across video segments, uniformly average all clips is obviously not the best strategy and can only achieve limited accuracy. The method according to embodiments of the present disclosure achieves the best 68.71% top-1 accuracy due to the introduction of inter-clip interdependencies via the Bi-directional Attention mechanism.

Table 1

Accuracy comparison of different action recognition techniques in Kinetics-600

| Action recognition techniques | Top-1 Accuracy (%) |
|---|---|
| 3D ResNet-101 + Central clip | 58.58 |
| 3D ResNet-101 + 10 clips average | 65.30 |
| The method (back bone: 3D ResNet-101) | 68.71 |

Below details of processing the set of clip descriptors via a Bi-directional Attention mechanism are illustrated in conjunction with the network architecture in FIG. 3.

In some embodiments, for processing the set of clip descriptors via a Bi-directional Attention mechanism at block 220, for each clip descriptor of the set of clip descriptor, firstly, a plurality of dot-product attention processes are performed on the each clip descriptor, and a plurality of global clip descriptors are obtained. Then, the plurality of global clip descriptors are concatenated and projected, and a multi-headed global clip descriptor of the each clip descriptor is obtained. The multi-headed global clip descriptor is configured to indicate the global representation of the video.

For example, for a clip descriptor, h dot-product attention processes are performed on the clip descriptor, and h global clip descriptors are obtained for the clip descriptor, where h is greater than or equal to 2.

Details are illustrated in conjunction with the network architecture in FIG. 3. As described that the set of clip descriptor is V = {v₁, v₂, ..., v_{c}}, a clip descriptor v₂ is taken as an example to describe. A global clip descriptor of the clip descriptor v₂ is marked as headᵢ, a multi-headed global clip descriptor of the clip descriptor v₂ is marked as MultiHead(v₂), and then the global clip descriptor headᵢ and the multi-headed global clip descriptor are defined as the following formula.

$$\begin{matrix}h e a {d}_{i} = \text{BA} \left({v}_{2} ; {\text{W}}^{\text{hi}}\right) ; \text{Whi} = \left\{{\text{W}}^{\text{hi}} {}_{\text{q}} , {\text{W}}^{\text{hi}} {}_{\text{k}} , {\text{W}}^{\text{hi}} {}_{\text{v}} , {\text{W}}^{\text{hi}} {}_{\text{z}}\right\} , \\ \text{MultiHead} \left({v}_{2}\right) = \text{Concat} \left(h e a {d}_{1} , … \text{,} h e a {d}_{h}\right) {\text{W}}^{\text{O}} ,\end{matrix}$$

where the function BA( ) represents a dot-product attention process, in which W^{hi}_{q}, W^{hi}ₖ, W^{hi}ᵥ, W^{hi}_{z} are denote linear transform matrices, respectively, W^{hi} is the i^{th} head attention, and W^{o} is the linear transform matrices to deliver the final multi-headed global clip descriptor.

Thus, for the clip descriptor v₂, it has h global clip descriptor, i.e. head₁, ... , headₕ, and the final multi-headed global clip descriptor MultiHead(v₂). Similarly, these are also used for other clip descriptors in the set of clip descriptor V = {v₁, v₂, ..., v_{c}}, which is not described again herein.

Further, in some examples, for performing one dot-product attention process of the plurality of dot-product attention processes on the each clip descriptor, firstly, linear-projection is performed on the each clip descriptor and a first vector, a second vector, and a third vector of the each clip descriptor are obtained. Then, a dot-product operation and a normalization operation are performed on the first vector of the each clip descriptor and a second vector of each other clip descriptor in the set of clip descriptors, and obtaining a relationship-value between the each clip descriptor and the each other clip descriptor is obtained. Then a dot-product operation is performed on the relationship-value and a third vector of the each other clip descriptor, such that a plurality of values are obtained. Then, the plurality of values are summed and linear-projection is performed on the summed values, such that one of the plurality of global clip descriptors is obtained.

For each clip descriptor, a first vector, a second vector, and a third vector of the clip descriptor may be Query-vector Q, Key-vector K, and Value-vector V. That is, the first vector is the vector Q, the second vector is the vector K, and the third vector is the vector V.

The relationship-value between a clip descriptor and another clip descriptor in the set of clip descriptors indicates the relationship between a clip corresponding to the clip descriptor and the another clip corresponding to another clip descriptor.

Details are illustrated in conjunction with the network architecture in FIG. 3 again. As described that the set of clip descriptor is V = {v₁, v₂, ..., v_{C}}. One dot-product attention process is defined as in the following formula. As described above, the function BA () represents a dot-product attention process. that is, this dot-product attention process herein is same to the dot-product attention process in above embodiments

$$B A ( {v}_{1} ) = {W}_{z} {\sum }_{i} \frac{\left({W}_{q} {v}_{i}\right) {\left({W}_{s} {v}_{i}\right)}^{T}}{N \left(v\right)} \left({W}_{v} {v}_{j}\right)$$

where i is the index of the query positions, and vᵢ represents the i^{th} clip descriptor in the set V, and j enumerates all other clip positions, and vⱼ represents other clip descriptor in the set V. W_{q}, Wₖ, Wᵥ and W_{Z} denote linear transform matrices. W_{q}vᵢ is the vector Q of the clip descriptor vᵢ, Wₖvⱼ is the vector K of the clip descriptor vⱼ, Wᵥvⱼ is the vector V of the clip descriptor vⱼ, (W_{q}vᵢ)(Wᵥvⱼ) denotes the relationship between the clip i and the clip j, and N(v) is the normalization factor.

In these examples, as one dot-product attention process is performed on a clip descriptor, highly optimized matrix multiplication code is used. Thus, due to the dot-product attention process, this is much faster and more space-efficient in practice for action recognition in video.

As described above, the multi-headed global clip descriptor is configured to indicate the global representation of the video. In some embodiments, the global representation of the video is indicated by weighted-averaging the multi-headed global clip descriptor of the each clip descriptor. That is, the global representation of the video is a weighted-average of a plurality of multi-headed global clip descriptors.

Details are illustrated in conjunction with the network architecture in FIG. 3 again. As described that the set of clip descriptor is V = {v₁, v₂, ..., v_{c}}. The global representation of the video is denoted as v′, which is defined by the following formula.

$$\text{v′} = {Σ}_{\text{i}} \text{MultiHead(} {v}_{\text{i}} ) / \text{C}$$

where C is the number of clips, and MultiHead(vi) indicates the multi-headed global clip descriptor of the clip descriptor vᵢ.

In some embodiments, the video includes a plurality of actions, and the actions have a plurality of class-labels. For performing video-classification for the global representation of the video, video-classification is performed for the global representation of the video according to a respective loss function, wherein the respective loss function corresponds to one class-label of the plurality of class-labels.

Further, in some examples, each class-label of the plurality of class-labels is configured as one classifier for the video-classification. That is, each class-label is treated as an independent classifier in the video-classification. Specifically, in some examples, the one classifier is obtained by training features of a training-video extracted from the CNN.

Details are illustrated in conjunction with the network architecture in FIG. 3 again. As described that the set of clip descriptor is V = {v₁, v₂, ..., v_{C}}. The video-classification is based on v′, and the output for the video-classification is defined by the following formula.

$$o = {σ}_{\text{sigmoid}} \left({\text{W}}_{\text{c}} \text{v′}\right)$$

where W_{c} is weights of fully connected layers corresponding to the 3D CNN.

In the example of FIG. 3, the video-classification adopts a linear classifier, which uses a sigmoid function as its mapping function The output of the linear classifier can be a range of real numbers, and the output of the linear classifier can be mapped to a probability of a to-be-classified image containing an target image with a predefined class, using a projection function with the set of real numbers as the independent variable and [0, 1] as the dependent variable. classifier. The dependent variable of the mapping function is positively correlated with the independent variable. That is, the dependent variable increases with the increase of the independent variable and decreases with the decrease of the independent variable. For example, when the mapping function can be a sigmoid function, which is specified as S(x) = 1 / (e^{-x}+1), where e is the natural base, x is the independent variable, and S(x) is the dependent variable. The mapping function can be integrated into the linear classifier so that the linear classifier directly outputs a probability of a to-be-classified image containing a target image with a predefined class.

Further, in some examples, the respective loss function is in a form of binary cross entropy. Specifically, in the example of the network architecture in FIG. 3, the respective loss function is marked as L_{BCE}, and the respective loss function may be defined by the following formula.

$${L}_{B C E} = - {w}_{i} \left[{y}_{i} l o g {o}_{i} + \left(1 - {y}_{i}\right) l o g \left(1 - {o}_{i}\right)\right]$$

where oᵢ is the output of a classifier in the video-classification (i.e. the output of the network architecture), and wᵢ is sample weighting parameter for the classifier.

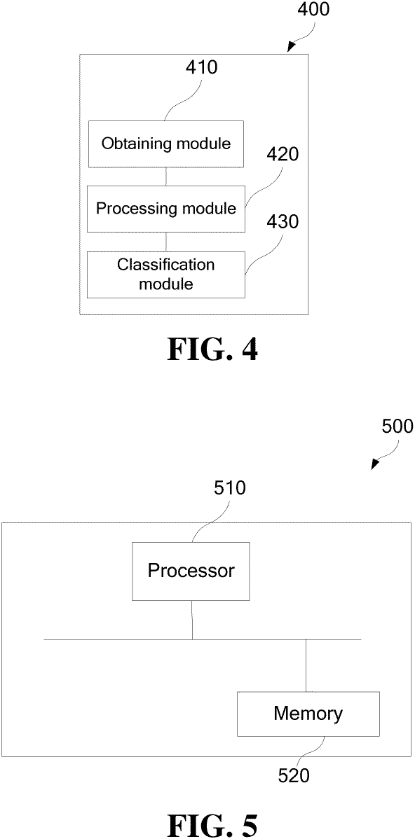

FIG. 4 is a structural schematic view of an apparatus for action recognition in a video according to some embodiments of the present disclosure. The apparatus 400 may include an obtaining module 410, a processing module 420, and a classification module 430.

The obtaining module 410 may be used for inputting a plurality of consecutive clips divided from the video into a convolutional neural network (CNN), and obtaining a set of clip descriptors. The processing module 420 may be used for processing the set of clip descriptors via a Bi-directional Attention mechanism, and obtaining a global representation of the video. The classification module 430 may be used for performing video-classification for the global representation of the video such that action recognition is achieved.

In some embodiments, the processing module 420 is configured for, for each clip descriptor of the set of clip descriptor, performing a plurality of dot-product attention processes on the each clip descriptor, and obtaining a plurality of global clip descriptors; and concatenating and projecting the plurality of global clip descriptors, and obtaining a multi-headed global clip descriptor of the each clip descriptor; and the multi-headed global clip descriptor is configured to indicate the global representation of the video.

In some embodiments, performing one of a plurality of dot-product attention processes on the each clip descriptor includes: performing linear-projection on the each clip descriptor and obtaining a first vector, a second vector, and a third vector of the each clip descriptor; performing a dot-product operation and a normalization operation on the first vector of the each clip descriptor and a second vector of each other clip descriptor in the set of clip descriptors, and obtaining a relationship-value between the each clip descriptor and the each other clip descriptor; performing a dot-product operation on the relationship-value and a third vector of the each other clip descriptor, such that a plurality of values are obtained; and summing the plurality of values and performing linear-projection on the summed values, such that one of the plurality of global clip descriptors is obtained.

In some embodiments, the global representation of the video is indicated by weighted-averaging the multi-headed global clip descriptor of the each clip descriptor.

In some embodiments, the video includes a plurality of actions, and the actions have a plurality of class-labels; and the classification module is configured for performing video-classification for the global representation of the video according to a respective loss function, wherein the respective loss function corresponds to one class-label of the plurality of class-labels.

In some embodiments, the respective loss function is in a form of binary cross entropy.

In some embodiments, each class-label of the plurality of class-labels is configured as one classifier for the video-classification.

In some embodiments, the one classifier is obtained by training features of a training-video extracted from the CNN.

In some embodiments, the CNN includes a plurality of convolutional layers, and a convolutional kernel for each convolutional layer in the CNN is in a plurality of dimensions; and the obtaining module 410 is configured for, for each convolutional layer of the plurality of convolutional layers, computing data of the plurality of consecutive clips among the plurality of dimensions simultaneously, such that the set of clip descriptors is obtained.

It should be noted that, the above descriptions for the methods for searching image in the above embodiments, are also appropriate for the apparatus of the exemplary embodiments of the present disclosure, which will be not described herein.

FIG. 5 is a structural schematic view of an electronic device according to some embodiments of the present disclosure. The electronic device 500 may include a processor 510 and a memory 520, which are coupled together.

The memory 520 is configured to store executable program instructions. The processor 510 may be configured to read the executable program instructions stored in the memory 520 to implement a procedure corresponding to the executable program instructions, so as to perform any methods for searching images as described in the previous embodiments or a method provided with arbitrary and non-conflicting combination of the previous embodiments, or any methods for indexing images as described in the previous embodiments or a method provided with arbitrary and non-conflicting combination of the previous embodiments.

The electronic device 500 may be a computer, a sever, etc. in one example. The electronic device 500 may be a separate component integrated in a computer or a sever in another example.

A non-transitory computer-readable storage medium is provided, which may be in the memory 520. The non-transitory computer-readable storage medium stores instructions, when executed by a processor, causing the processor to perform the method as described in the previous embodiments.

A person of ordinary skill in the art may appreciate that, in combination with the examples described in the embodiments disclosed in this specification, units and algorithm steps may be implemented by electronic hardware, computer software, or a combination thereof. In order to clearly describe the interchangeability between the hardware and the software, the foregoing has generally described compositions and steps of every embodiment according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present disclosure.

It can be clearly understood by a person skilled in the art that, for the purpose of convenient and brief description, for a detailed working process of the foregoing system, apparatus and unit, reference may be made to the corresponding process in the method embodiments, and the details will not be described herein again.

In the several embodiments provided in the present disclosure, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. A part or all of the units herein may be selected according to the actual needs to achieve the objectives of the solutions of the embodiments of the present disclosure.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of a software functional unit.

When the integrated unit are implemented in a form of a software functional unit and sold or used as an independent product, the integrated unit may be stored in a computer- readable storage medium. Based on such an understanding, the technical solutions of the present disclosure essentially, or the part contributing to the prior art, or all or a part of the technical solutions may be implemented in a form of software product. The computer software product is stored in a storage medium, for example, non-transitory computer-readable storage medium, and includes several instructions for instructing a computer device (which may be a personal computer, a server, or a network device) to perform all or a part of the steps of the methods described in the embodiments of the present disclosure. The foregoing storage medium includes any medium that can store program codes, such as a USB flash disk, a removable hard disk, a read-only memory (ROM), a random access memory (RAM), a magnetic disk, or an optical disk.

The foregoing descriptions are merely specific embodiments of the present disclosure, but are not intended to limit the protection scope of the present disclosure. Any equivalent modification or replacement figured out by a person skilled in the art within the technical scope of the present disclosure shall fall within the protection scope of the present disclosure. Therefore, the protection scope of the present disclosure shall be subject to the protection scope of the claims.

What is claimed is:

1. A method for action recognition in a video, comprising:
inputting a plurality of consecutive clips divided from the video into a convolutional neural network (CNN), and obtaining a set of clip descriptors;
processing the set of clip descriptors via a Bi-directional Attention mechanism, and obtaining a global representation of the video; and
performing video-classification for the global representation of the video such that action recognition is achieved.

2. The method of claim 1, wherein the processing the set of clip descriptors via the Bi-directional Attention mechanism comprises:
for each clip descriptor of the set of clip descriptor:
performing a plurality of dot-product attention processes on the each clip descriptor, and obtaining a plurality of global clip descriptors; and
concatenating and projecting the plurality of global clip descriptors, and obtaining a multi-headed global clip descriptor of the each clip descriptor; and
the multi-headed global clip descriptor is configured to indicate the global representation of the video.

3. The method of claim 2, wherein performing one dot-product attention process of the plurality of dot-product attention processes on the each clip descriptor comprises:
performing linear-projection on the each clip descriptor and obtaining a first vector, a second vector, and a third vector of the each clip descriptor;
performing a dot-product operation and a normalization operation on the first vector of the each clip descriptor and a second vector of each other clip descriptor in the set of clip descriptors, and obtaining a relationship-value between the each clip descriptor and the each other clip descriptor;
performing a dot-product operation on the relationship-value and a third vector of the each other clip descriptor, such that a plurality of values are obtained; and
summing the plurality of values and performing linear-projection on the summed values, such that one of the plurality of global clip descriptors is obtained.

4. The method of claim 2, wherein the global representation of the video is indicated by weighted-averaging the multi-headed global clip descriptor of the each clip descriptor.

5. The method of claim 1, wherein the video comprises a plurality of actions, and the actions have a plurality of class-labels; and
the performing video-classification for the global representation of the video comprises:
performing video-classification for the global representation of the video according to a respective loss function, wherein the respective loss function corresponds to one class-label of the plurality of class-labels.

6. The method of claim 5, wherein the respective loss function is in a form of binary cross entropy.

7. The method of claim 5, wherein each class-label of the plurality of class-labels is configured as one classifier for the video-classification.

8. The method of claim 7, wherein the one classifier is obtained by training features of a training-video extracted from the CNN.

9. The method of claim 1, wherein the CNN comprises a plurality of convolutional layers, and a convolutional kernel for each convolutional layer in the CNN is in a plurality of dimensions; and
the inputting the plurality of consecutive clips divided from the video into the convolutional neural network (CNN) and obtaining a set of clip descriptors comprises:
for each convolutional layer of the plurality of convolutional layers:
computing data of the plurality of consecutive clips among the plurality of dimensions simultaneously, such that the set of clip descriptors is obtained.

10. An electronic device, comprising a processor and a memory storing instructions, when executed by the processor, causing the processor to perform a method for action recognition in a video, the method comprising:
inputting a plurality of consecutive clips divided from the video into a convolutional neural network (CNN), and obtaining a set of clip descriptors;
processing the set of clip descriptors via a Bi-directional Attention mechanism, and obtaining a global representation of the video; and
performing video-classification for the global representation of the video such that action recognition is achieved.

11. The electronic device of claim 10, wherein the processing the set of clip descriptors via a Bi-directional Attention mechanism comprises:
for each clip descriptor of the set of clip descriptor:
performing a plurality of dot-product attention processes on the each clip descriptor, and obtaining a plurality of global clip descriptors; and
concatenating and projecting the plurality of global clip descriptors, and obtaining a multi-headed global clip descriptor of the each clip descriptor; and
the multi-headed global clip descriptor is configured to indicate the global representation of the video.

12. The electronic device of claim 11, wherein performing one dot-product attention process of the plurality of dot-product attention processes on the each clip descriptor comprises:
performing linear-projection on the each clip descriptor and obtaining a first vector, a second vector, and a third vector of the each clip descriptor;
performing a dot-product operation and a normalization operation on the first vector of the each clip descriptor and a second vector of each other clip descriptor in the set of clip descriptors, and obtaining a relationship-value between the each clip descriptor and the each other clip descriptor;
performing a dot-product operation on the relationship-value and a third vector of the each other clip descriptor, such that a plurality of values are obtained; and
summing the plurality of values and performing linear-projection on the summed values, such that one of the plurality of global clip descriptors is obtained.

13. The electronic device of claim 11, wherein the global representation of the video is indicated by weighted-averaging the multi-headed global clip descriptor of the each clip descriptor.

14. The electronic device of claim 10, wherein the video comprises a plurality of actions, and the actions have a plurality of class-labels; and
the performing video-classification for the global representation of the video comprises:
performing video-classification for the global representation of the video according to a respective loss function, wherein the respective loss function corresponds to one class-label of the plurality of class-labels.

15. The electronic device of claim 14, wherein the respective loss function is in a form of binary cross entropy.

16. The electronic device of claim 14, wherein each class-label of the plurality of class-labels is configured as one classifier for the video-classification.

17. The electronic device of claim 16, wherein the one classifier is obtained by training features of a training-video extracted from the CNN.

18. The electronic device of claim 10, wherein the CNN comprises a plurality of convolutional layers, and a convolutional kernel for each convolutional layer in the CNN is in a plurality of dimensions; and
the inputting the plurality of consecutive clips divided from the video into the convolutional neural network (CNN) and obtaining the set of clip descriptors comprises:
for each convolutional layer of the plurality of convolutional layers:
computing data of the plurality of consecutive clips among the plurality of dimensions simultaneously, such that the set of clip descriptors is obtained.

19. A non-transitory computer-readable storage medium, storing instructions, when executed by a processor, causing the processor to perform a method for action recognition in a video, which comprising:
inputting a plurality of consecutive clips divided from the video into a convolutional neural network (CNN), and obtaining a set of clip descriptors;
processing the set of clip descriptors via a Bi-directional Attention mechanism, and obtaining a global representation of the video; and
performing video-classification for the global representation of the video such that action recognition is achieved.

20. The non-transitory computer-readable storage medium of claim 19, wherein the processing the set of clip descriptors via a Bi-directional Attention mechanism comprises:
for each clip descriptor of the set of clip descriptor:
performing a plurality of dot-product attention processes on the each clip descriptor, and obtaining a plurality of global clip descriptors; and
concatenating and projecting the plurality of global clip descriptors, and obtaining a multi-headed global clip descriptor of the each clip descriptor; and
the multi-headed global clip descriptor is configured to indicate the global representation of the video.
